(19) United States
(12) Patent Application Publication
(10) Pub. No.: US 2007/0066300 A1
(43) Pub. Date: Mar. 22, 2007

(54) Wireless communication apparatus

(75) Inventors: Toshihiro Nishimura, Fukuoka (JP); Noriko Gondou, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/475,889

(22) Filed: Jun. 28, 2006

(30) Foreign Application Priority Data
Jun. 30, 2005 (JP) 2005-191428

(51) Int. Cl. H04Q 7/20

(52) U.S. Cl. 455/426.1; 455/462

(57) ABSTRACT

There are provided a main master station for transmitting control data by setting, as a synchronization slot, a specific transmission slot of a time division multiple access communication frame, a sub master station for transmitting the control data by setting, as a broadcast slot, a slot which does not overlap with the synchronization slot in synchronization with the main master station, and a slave station capable of communicating with the main master station and the sub master station, and the slave station waits for the control data transmitted from the sub master station in a time width decided based on a time position of the synchronization slot upon receipt of the control data from the main master station, and carries out an incoming call operation while continuously receiving the control data from either the main master station or the sub master station in an incoming call received from the other.

### BACKGROUND OF THE INVENTION

The present invention relates to a wireless communication apparatus in which a master station and a slave station carry out a communication in a time division multiplex.

There is a communication system in which a master station and a plurality of slave stations carry out a communication in TDMA (time division multiple access). For example, when a cordless telephone base unit 20a and a plurality of cordless telephone remote units 20b in a cordless telephone 20 are set to be a master station and a slave station respectively as shown in FIG. 14, one cordless telephone remote unit 20b is disposed in a children's room on a second floor and one cordless telephone remote unit 20b is disposed in a bedroom so that it is not necessary to go to the cordless telephone base unit 20a for talking every incoming call if the cordless telephone base unit 20a is disposed in a living room on a first floor. Therefore, this is very convenient (In FIG. 14, only one cordless telephone remote unit 20b is shown).

In an ordinary family, moreover, an intercom 21 with a camera is disposed in some cases. Referring to the intercom 21 with a camera, an outdoor apparatus 21a including a camera, a microphone, a speaker and a ringing button for ringing a chime is provided on a gatepost and an indoor apparatus 21b including a monitor, a microphone, a speaker and a response button for setting a talking state is provided in a living room.

When a visitor presses down the ringing button, the chime is rung through the indoor apparatus 21b so that the visitor can be recognized. In order to make a response, however, it is necessary to go to the living room in which the indoor apparatus 21b is provided.

If there is such an outdoor apparatus as to give a notice by wireless also in a place apart from the indoor apparatus 21b when the ringing button is pressed down, it is not necessary to especially go to the living room in the same manner as the cordless telephone 20, which is supposed to be highly convenient. In other words, by setting the indoor apparatus 21b and the outdoor apparatus 21c to be the master and slave stations respectively in order to carry out a communication, it is possible to give a notice of a visitor in a position placed apart or to have a conversation with the visitor. A wireless intercom utilizing a wireless communication has been described in Patent Document 1 (Prior Art 1). Referring to the wireless intercom according to the Patent Document 1, there has been described a method of implementing a wireless communication between a private room base unit with a monitor and an extension base unit with a monitor by connecting a private room base unit wireless transmitting/receiving adaptor to a private room base unit with the monitor and connecting an extension base unit wireless transmitting/receiving adaptor for carrying out a wireless communication with a base unit wireless transmitting/receiving adaptor to the extension base unit with the monitor.

In the cordless telephone and the wireless intercom, a plurality of remote units can be connected to one base unit. However, the remote unit is expensive. For this reason, realistically, one base unit and one or two remote units are used together in most cases. The remote unit is disposed in only a room having a high frequency of use, for example, a living room or a bedroom. In the case in which there are the cordless telephone and the wireless intercom, the number of the remote units which can be connected to each base unit is increased, resulting in an enhancement in a convenience if respective base units are connected to each other by a cable and respective services can be used in a remote unit on a partner side. Thus, Patent Document 2 has described a cordless telephone capable of using an intercom service through the remote unit of the cordless telephone by connecting the intercom to the cordless telephone (Prior Art 2). Referring to the cordless telephone according to the Patent Document 2, there has been described a method of connecting a base unit of the cordless telephone to the intercom, capable of giving a notice to the cordless telephone, giving an intercom incoming call by means of the base unit and the remote unit in the cordless telephone and responding to the incoming call of the intercom on the cordless telephone side if there is the intercom incoming call, and furthermore, capable of calling the remote unit from the base unit or the intercom and transmitting a simple message from the base unit to the remote unit without influencing outside line talking by using the technique of a digital cordless telephone (PHS) also while the cordless telephone is talking to an outside line.

If the Prior Art 1 and the Prior Art 2 are applied to connect a cordless telephone to a wireless intercom by wireless, furthermore, the convenience can be enhanced still more. Thus, Patent Document 3 has described a method of carrying out a communication between two wireless communication systems by wireless (Prior Art 3). The intercom apparatus according to the Patent Document 3 is constituted by an intercom unit having a camera to be attached to an entrance and a body unit having a display portion for displaying an image transmitted from the intercom unit, the body unit is provided with a first wireless transmitting/receiving portion for carrying out a wireless communication with the intercom unit and a second wireless transmitting/receiving portion for carrying out the wireless communication with a cell phone or a PHS telephone, and the intercom unit provided with the two wireless transmitting/receiving portions is utilized to implement a communication between a wireless communication system on an intercom side and a wireless communication system such as a cell phone through a wireless communication.

By combining these techniques, it is possible to construct a system in which a cordless telephone and a wireless intercom are connected by wireless and mutual remote units can be utilized for other services, and all of them are constituted by a wireless connection.

| | |
|---|---|
| [Patent Document 1] | JP-A-2003-198737 Publication |
| [Patent Document 2] | JP-A-6-205089 Publication |
| [Patent Document 3] | JP-A-2002-152392 Publication |

In the system in which the cordless telephone and the intercom are connected to each other and the remote unit of the cordless telephone is connected according to the Prior Art 2, however, there has not been disclosed an operation to be carried out when a simultaneous call is generated from the cordless telephone side and the intercom side. In the case in which an intercom incoming call is received during the use of the telephone, moreover, a notice of the intercom incoming call is only received through a superposing sound. Therefore, it is necessary to hold the telephone or disconnect the telephone and to carry out voice talking to the intercom side. Thus, it is impossible to confirm a visitor on the intercom side without interrupting the telephone during a communication. Furthermore, there has not been disclosed an operation to be carried out when an outside line incoming call is received during a response to the intercom side through the cordless telephone.

In addition, in a system implemented by a combination of the Prior Arts in which a cordless telephone and a wireless intercom are connected to each other by wireless, mutual remote units can be utilized for other services and all of them are connected to each other by wireless, it is necessary to provide wireless transmitting/receiving portions corresponding to respective wireless communication apparatuses in one wireless communication apparatus for connecting wireless communication systems. Therefore, there is a problem in that a size of the wireless communication apparatus is increased and a price is also raised.

In consideration of the problems, it is an object of the invention to provide a wireless communication apparatus having a high convenience which can give a notice of an incoming call of one of services during an incoming call of the other service or can confirm an incoming call of one of services in a communication with the other service without requiring a new wireless transmitting/receiving apparatus for a wireless communication between a cordless telephone and a wireless intercom.

In order to achieve the object, a wireless communication apparatus includes wireless communicator for wireless communicating with a telephone base unit connected to a communication line and wireless communicating with an indoor apparatus connected to an outdoor apparatus having a camera for capturing an image of a visitor; display for displaying data; and controller for causing the display to display information about a call received from the communication line through the telephone base unit and image data captured by the camera of the outdoor apparatus through the indoor apparatus.

The wireless communication apparatus according to the invention comprises a main master station for transmitting control data by setting a specific transmission slot of a time division multiple access communication frame as a synchronization slot, a sub master station for receiving the control data in the synchronization slot and transmitting the control data by setting, as a broadcast slot, a slot which does not overlap with the synchronization slot if necessary in synchronization with the main master station, and a slave station capable of communicating with the main master station and the sub master station through a receipt slot and the transmission slot which are synchronized with the main master station. Upon receipt of the control data from the main master station, the slave station waits for the control data from the sub master station in a time width decided based on a time position of the synchronization slot receiving the control data. In the case in which a notice of an incoming call is received from either the main master station or the sub master station, an incoming call operation is started while the receipt of other control data is continuously carried out. Consequently, it is possible to obtain an advantage that other incoming calls can be detected also during an incoming call operation from either the main master station or the sub master station without requiring a plurality of wireless transmitting/receiving apparatuses.

### BRIEF DESCRIPTION OF THE DRAWINGS

FIG. 1 is a view showing a structure of a wireless communication apparatus according to a first embodiment of the invention,

FIG. 2 is a diagram for explaining a structure of an intercom according to the first embodiment of the invention,

FIG. 3 is a diagram for explaining a structure of a cordless telephone base unit of a cordless telephone according to the first embodiment of the invention,

FIG. 4 is a diagram for explaining a structure of a cordless telephone remote unit of the cordless telephone according to the first embodiment of the invention,

FIGS. 5(A) and 5(B) are diagrams for explaining a format of packet data,

FIG. 6 is a diagram for explaining the states of a transmission slot and a receipt slot in the execution of a communication in the wireless communication apparatus according to the first embodiment of the invention,

FIG. 7 is a diagram for explaining the states of the transmission slot and the receipt slot in the execution of the communication in the wireless communication apparatus according to the first embodiment of the invention,

FIG. 8 is a diagram for explaining the states of the transmission slot and the receipt slot in the execution of the communication in the wireless communication apparatus according to the first embodiment of the invention,

FIG. 9 is a diagram for explaining a structure of a cordless telephone remote unit in a cordless telephone according to a second embodiment of the invention,

FIGS. 10(A) to 10(D) are views showing an example of a screen display in the case in which two incoming calls are generated at a time in a wireless communication apparatus according to the second embodiment of the invention,

FIGS. 11(A) and 11(B) are views showing an example of a screen display in the case in which another incoming call is generated during talking in the wireless communication apparatus according to the second embodiment of the invention,

FIGS. 12(A) to 12(C) are views showing an example of a display method selecting and setting screen in the case in which two incoming calls are generated at a time in the wireless communication apparatus according to the second embodiment of the invention,

FIGS. 13(A) and 13(B) are views showing an example of a display in the case in which a size of a visitor image display during an entrance incoming call is changed in the wireless communication apparatus according to the second embodiment of the invention, and

FIG. 14 is a view showing a structure comprising a cordless telephone and an intercom.

### DETAILED DESCRIPTION OF THE EMBODIMENTS

### First Embodiment

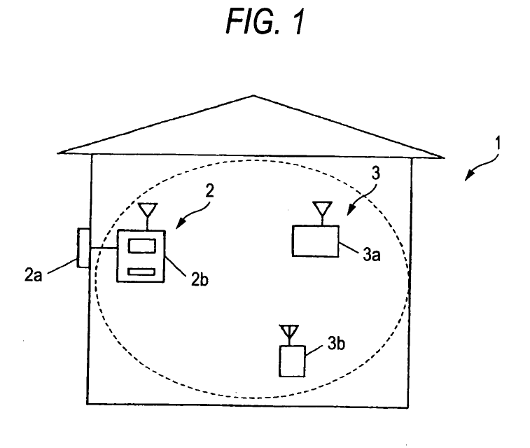

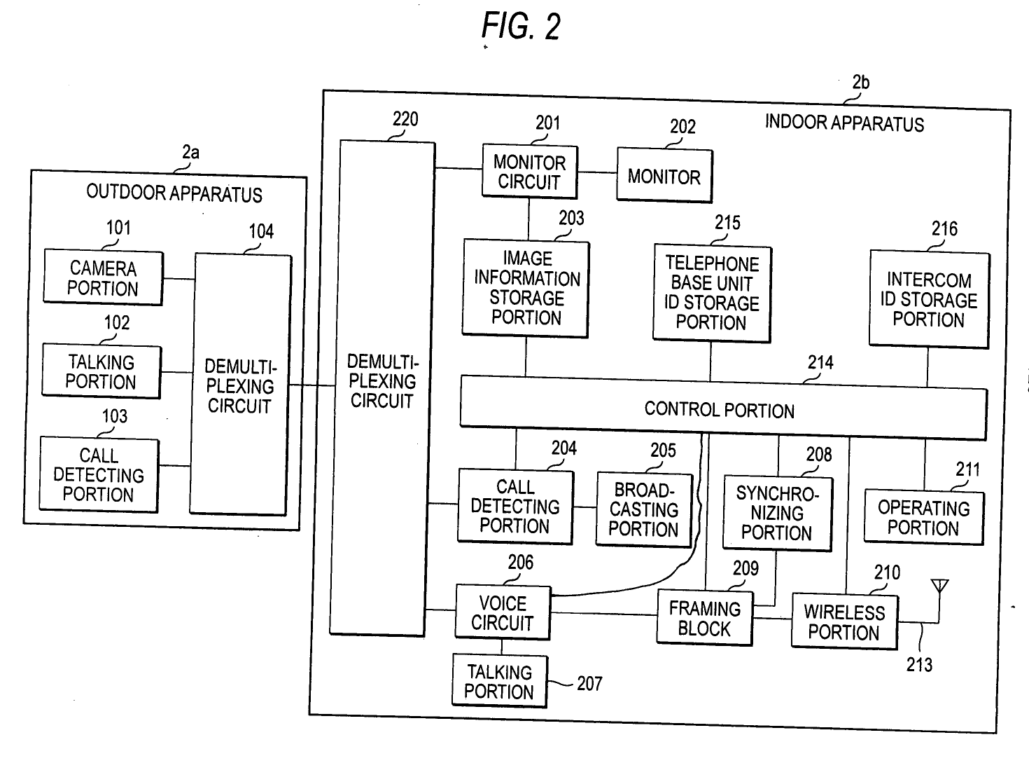

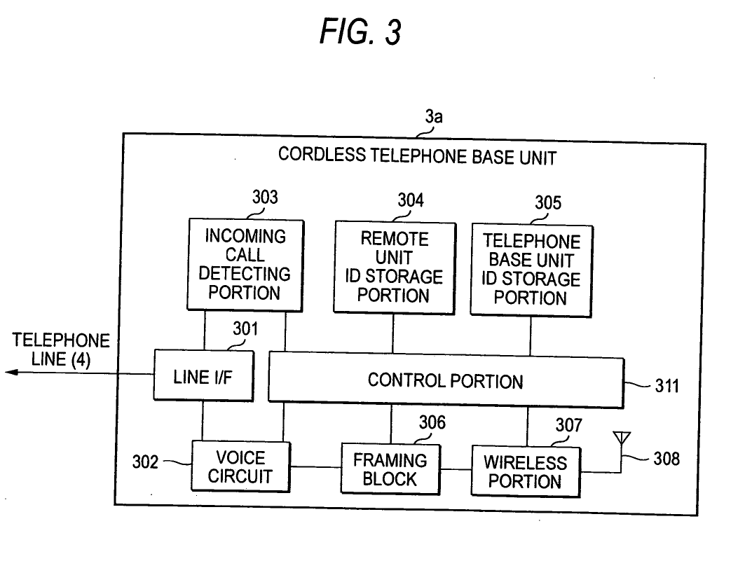

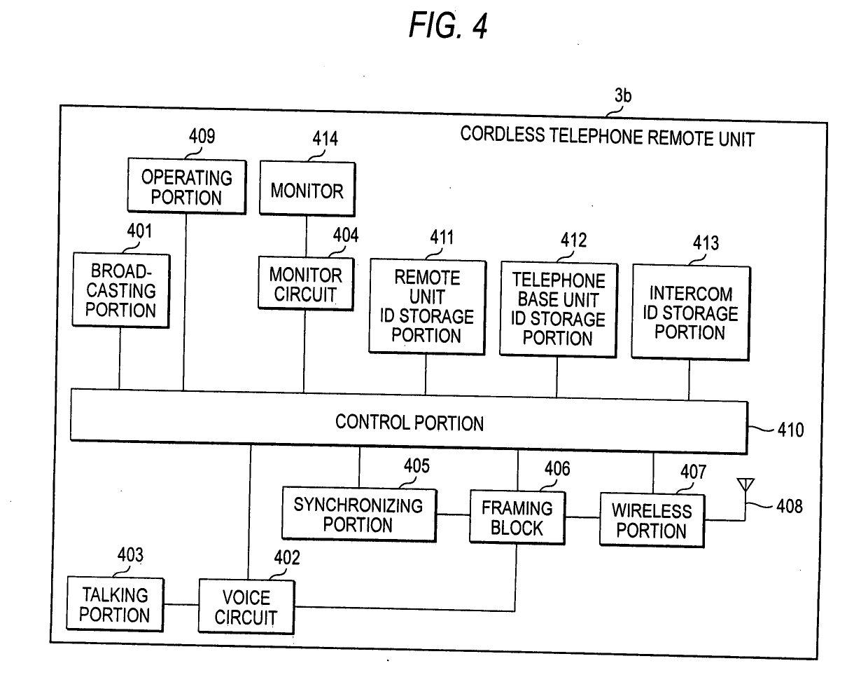

A structure of a wireless communication apparatus according to a first embodiment of the invention will be described below with reference to FIGS. 1 to 4. FIG. 1 is a view showing a structure of a wireless communication apparatus according to the first embodiment of the invention. FIG. 2 is a diagram for explaining a structure of an intercom according to the first embodiment of the invention. FIG. 3 is a diagram for explaining a structure of a cordless telephone base unit of a cordless telephone according to the first embodiment of the invention. FIG. 4 is a diagram for explaining a structure of a cordless telephone remote unit of the cordless telephone according to the first embodiment of the invention.

As shown in FIG. 1, a wireless communication system 1 according to the first embodiment of the invention comprises an intercom 2 and a cordless telephone 3. The intercom 2 is constituted by an outdoor apparatus 2a and an indoor apparatus 2b. The cordless telephone 3 is constituted by a cordless telephone base unit 3a and a cordless telephone remote unit 3b. Although only one cordless telephone remote unit 3b is shown in FIG. 1, a plurality of cordless telephone remote units 3b may be provided. In the wireless communication apparatus 1 according to the first embodiment, the cordless telephone base unit 3a serves as a main master station, the indoor apparatus 2b serves as a sub master station and the cordless telephone remote unit 3b serves as a slave station, and a communication is carried out by a wireless time division multiple access.

As shown in FIG. 2, the intercom 2 has the outdoor apparatus 2a and the indoor apparatus 2b connected to each other by a cable. The outdoor apparatus 2a includes a camera portion 101 for capturing an image of a visitor, a talking portion 102 for talking to the visitor, a call detecting portion 103 for detecting a call by the visitor and transmitting a call request to the indoor apparatus 2b, and a demultiplexing circuit 104 for multiplexing or de-multiplexing image data, voice data and a call request of the visitor whose image is captured, thereby carrying out a communication with the indoor apparatus 2b.

The indoor apparatus 2b includes a monitor circuit 201, a monitor 202, an image information storage portion 203, a call detecting portion 204, a broadcasting portion 205, a voice circuit 206, a talking portion 207, a synchronizing portion 208, a framing block 209, a wireless portion 210, an operating portion 211, an antenna 213, a control portion 214, a telephone base unit ID storage portion 215, an intercom ID storage portion 216, and a demultiplexing circuit 220.

The monitor circuit 201 is connected to the demultiplexing circuit 220 and displays, on the monitor 202, image data transferred from the outdoor apparatus 2a.

The image information storage portion 203 stores the image data transferred from the outdoor apparatus 2a through the monitor circuit 201 and outputs the same image data to the control portion 214.

The call detecting portion 204 is connected to the demultiplexing circuit 220 and detects a call request from the call detecting portion 103 in the outdoor apparatus 2a to ring a chime of the broadcasting portion 205, thereby broadcasting the arrival of the visitor to a user and giving a notice to the control portion 214.

The voice circuit 206 is connected to the demultiplexing circuit 220 and has the function of converting a voice signal input from a microphone of the talking portion 207 into voice data and transmitting the voice data to the outdoor apparatus 2a, converting the voice data received through the outdoor apparatus 2a into a voice signal and thus outputting the voice signal through a speaker of the talking portion 207, and relaying the voice data to the outdoor apparatus 2a when communicating with the cordless telephone remote unit 3b.

The synchronizing portion 208 is connected to the framing block 209 and the control portion 214 and carries out a synchronization in a preamble and a synchronization bit pattern on the head of a packet.

The framing block 209 is connected to the voice circuit 206, the wireless portion 210 and the control portion 214 and has the function of extracting a control data field and an information field from demodulation data based on a synchronizing signal and outputting them to the control portion 214 or the voice circuit 206.

The wireless portion 210 carries out a modulation and a demodulation for performing a communication through the time division multiple access and transmits/receives the data through the antenna 213.

The operating portion 211 includes a key to be pressed down in talking to the visitor.

The control portion 214 serves to generally control the outdoor apparatus 2a and the indoor apparatus 2b.

The telephone base unit ID storage portion 215 registers an ID to be identification information of the cordless telephone base unit 3a which is the main master station. The intercom ID storage portion 216 registers an ID of the self-apparatus which serves as the sub master station, and is connected to freely carry out reading from the control portion 214.

Next, the cordless telephone 3 will be described in detail with reference to FIGS. 3 and 4. First of all, the cordless telephone base unit 3a will be described with reference to FIG. 3.

As shown in FIG. 3, the cordless telephone base unit 3a includes a line IF 301, a voice circuit 302, an incoming call detecting portion 303, a remote unit ID storage portion 304, a telephone base unit ID storage portion 305, a framing block 306, a wireless portion 307, an antenna 308, and a control portion 311.

The line IF 301 is connected to a telephone line 4 and outputs a signal to the incoming call detecting portion 303, and furthermore, outputs a signal to the voice circuit 302. Moreover, an analog voice signal is sent from the voice circuit 302 to the telephone line 4.

The voice circuit 302 has the function of converting the voice signal into digital voice data and converting the voice data into the voice signal.

The incoming call detecting portion 303 is connected to the line IF 301 and the control portion 311, and detects an incoming call through a voice signal sent from the telephone line 4 and gives a notice to the control portion 311.

The remote unit ID storage portion 304 registers an ID of the cordless telephone remote unit 3b to be the slave station which serves as a communicating partner. The telephone base unit ID storage portion 305 registers an ID of the self-apparatus which serves as the main master station and is connected to freely carry out reading from the control portion 311.

The framing block 306 is connected to the voice circuit 302, the wireless portion 307 and the control portion 311, and has the function of extracting a control data field and an information field from demodulation data based on a synchronizing signal and outputting the same fields to the control portion 311 or the voice circuit 302.

The wireless portion 307 carries out a modulation and a demodulation for performing a communication through the time division multiple access and transmits/receives the data through the antenna 308.

The control portion 311 serves to generally control the cordless telephone base unit 3a.

Next, the cordless telephone remote unit 3b will be described in detail with reference to FIG. 4. As shown in FIG. 4, the cordless telephone remote unit 3b includes a broadcasting portion 401, a voice circuit 402, a talking portion 403, a monitor circuit 404, a synchronizing portion 405, a framing block 406, a wireless portion 407, an antenna 408, an operating portion 409, a control portion 410, a remote unit ID storage portion 411, a telephone base unit ID storage portion 412, an intercom ID storage portion 413, and a monitor 414.

The broadcasting portion 401 is connected to the control portion 410, and broadcasts an incoming call from the telephone line 4 and a notice of a visitor which is received from the intercom 2 through a call sound based on a notice received from the control portion 410.

The voice circuit 402 is connected to the control portion 410, and converts a voice signal input through a microphone of the talking portion 403 into voice data and outputs the same voice data to the control portion 410 and the framing block 406, and converts the voice data input from the control portion 410 or the framing block 406 into a voice signal and outputting the voice signal through a speaker of the talking portion 403.

The monitor circuit 404 is connected to the control portion 410 and displays, on the monitor 414, image data sent from the intercom 2 and information such as a telephone number of a partner or a communication time which is received from the cordless telephone base unit 3a.

The synchronizing portion 405 is connected to the framing block 406 and the control portion 410 and carries out a synchronization in a preamble and a synchronization bit pattern on the head of a packet.

The framing block 406 is connected to the voice circuit 402, the wireless portion 407 and the control portion 410 and has the function of extracting a control data field and an information field from demodulation data based on a synchronizing signal and outputting them to the control portion 410 or the voice circuit 402.

The wireless portion 407 carries out a modulation and a demodulation for performing a communication through the time division multiple access and transmits/receives the data through the antenna 408.

The operating portion 409 includes a number button to be used when inputting a transmitting destination telephone number, a key for carrying out on-hook/off-hook, and a button for responding to a visitor notice from the intercom 2.

The control portion 410 serves to generally control the cordless telephone remote unit 3b.

The remote unit ID storage portion 411 registers an ID of the self-apparatus to be the slave station. The telephone base unit ID storage portion 412 registers an ID of the cordless telephone base unit 3a to be the main master station. The intercom ID storage portion 413 registers an ID of the indoor apparatus 2b to be the sub master station. The remote unit ID storage portion 411, the telephone base unit ID storage portion 412 and the intercom ID storage portion 413 are connected to freely carry out reading from the control portion 410.

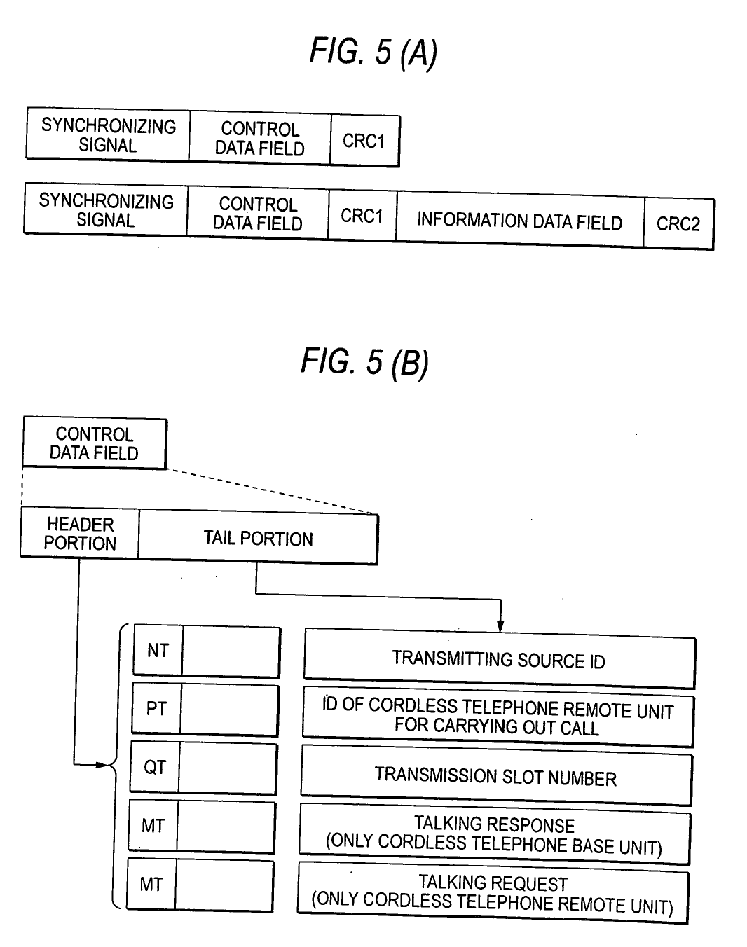

With reference to FIG. 5, description will be given to a format of packet data obtained when the indoor apparatus 2b, the cordless telephone base unit 3 and the cordless telephone remote unit 3b in the wireless communication apparatus according to the first embodiment of the invention which is constituted as described above carry out a communication by the time division multiple access. FIGS. 5(A) and 5(B) are diagrams for explaining the format of the packet data.

As shown in FIG. 5(A), the data packet includes a packet to be used when transmitting control data and a packet to be used when transmitting voice data and image data. All of the packet data also have a synchronizing signal and a control data field, and a field of a CRC (Cyclic Redundancy Check) 1 in which a check code of the control data field is stored.

The synchronizing signal is constituted by a preamble and a synchronization bit pattern, and serves to take a synchronization with a communication source. The control data field stores a message therein.

Moreover, the voice data and the image data are stored in the information field and a check code of the information field is stored in a CRC 2.

As shown in FIG. 5(B), the control data field is constituted by a header portion and a tail portion, and a message is stored in the header portion. In the tail portion, contents to be stored are varied depending on the contents of a message to be stored in the header portion. Referring to an NT message, for example, an ID of a transmitting source is stored. In other words, the NT message is used by the cordless telephone base unit 3a and the indoor apparatus 2b. The sub master station and the slave station which receive the NT message transmitted from the main master station can recognize that the main master station uses the slot. Moreover, the slave station receiving the NT message transmitted from the sub master station can recognize that the sub master station uses the slot.

Furthermore, an ID of the cordless telephone remote unit 3b for carrying out a call is stored in a PT message. In the case in which an incoming call is received from the telephone line 4, an ID of the cordless telephone remote unit 3b to which the cordless telephone base unit 3a gives a notice of the incoming call is stored. In the case in which a visitor arrives, the ID of the cordless telephone remote unit 3b for giving a notice of a call from the indoor apparatus 2b is stored. In the case in which all of the remote units are called at the same time, moreover, a special ID indicative of a call for all of them (for example, all have an ID of 0) is stored.

A QT message is used when giving a notice of a transmitting slot to a communicating partner. The sub master station and the slave station which receive the QT message transmitted from the main master station can recognize any of the slots in a frame through which the control signal is transmitted, and can synchronize the frame and the slot with the main master station.

An MT message is used by the cordless telephone base unit 3a and the indoor apparatus 2b and is used by the cordless telephone remote unit 3b. When an incoming call is received from the telephone line 4 and the PT message is transmitted from the cordless telephone base unit 3a to the cordless telephone remote unit 3b, a talking request based on the MT message is transmitted from the cordless telephone remote unit 3b subjected to off-hook, and a talking response based on the MT message is transmitted as a confirmation response from the cordless telephone base unit 3a. When the incoming call is received from the outdoor apparatus 2a and the PT message is transmitted from the indoor apparatus 2b to the cordless telephone remote unit 3b, similarly, a talking request based on the MT message is transmitted from the cordless telephone remote unit 3b subjected to the off-hook and a talking response based on the MT message is transmitted as a confirmation response from the indoor apparatus 2b.

With reference to FIGS. 1 to 4, next, description will be given to an operation to be carried out when the indoor apparatus 2b, the cordless telephone base unit 3a and the cordless telephone remote unit 3b perform a communication by using the packet data.

First of all, description will be given to an operation of the indoor apparatus 2b. As shown in FIG. 2, first of all, the control portion 214 sets the wireless portion 210 into a continuous receiving state and starts a synchronous acquiring operation. Then, packet data received by the wireless portion 210 and demodulated are transferred to the framing block 209.

The framing block 209 extracts a control data field of a synchronizing signal source from the demodulated packet data and outputs an ID of a transmitting source and a receiving slot number to the control portion 214 based on the received data of the control data field.

When the received ID is coincident with the ID registered in the telephone base unit ID storage portion 215, the control portion 214 sets, as a synchronization slot, a transmission slot receiving the ID registered in the telephone base unit ID storage portion 215 and the cordless telephone base unit 3a subsequently carries out a receipt in the same timing. Upon receipt of the control data for giving a notice of a slot transmitting a control signal, then, the synchronization of the frame and the slot with the cordless telephone base unit 3a (the main master station) is established. For example, when a notice of the fact that the slot transmitting the control signal from the cordless telephone base unit 3a is “1” is given, the frame timing is determined in such a manner that the slot receiving the control data (the synchronization slot) is set to be the slot 1. More specifically, the indoor apparatus 2b is operated by setting, as a receipt slot, the synchronization slot in which the cordless telephone base unit 3a transmits a control signal in the transmission slots on the master station side predetermined in the wireless communication apparatus after the synchronization of the frame and the slot with the cordless telephone base unit 3a is established. One of the slots excluding the synchronization slot for carrying out a receiving operation is selected as a broadcast slot from the transmission slots on the predetermined master station side in the wireless communication apparatus, and transmits the control data as the sub master station. In the embodiment, a next slot to the synchronization slot to be transmitted by the cordless telephone base unit 3a is set to be the broadcast slot of the indoor apparatus 2b.

The control portion 214 carries out a control for a transition to an idle state in which a receipt of a talking request from the cordless telephone remote unit 3b is waited by slots excluding slots corresponding to the synchronization slot and the broadcast slot in the transmission slots on the slave station (the cordless telephone remote unit 3b) side predetermined in the wireless communication apparatus.

When the transition to the idle state is carried out, the framing block 209 gives the synchronizing portion 208 a notice of the control data transferred from the cordless telephone base unit 3a. The synchronizing portion 208 outputs a synchronizing trigger signal to the framing block 209 when an ID of the received control data is coincident with an ID stored in the telephone base unit ID storage portion 215. The framing block 209 adjusts a timing of a frame/slot of a time division multiple access based on the synchronizing trigger signal and regulates the timing of the frame/slot of the time division multiple access in such a manner that a positional relationship among a timing for receiving a packet from the cordless telephone base unit 3a, a timing for transmitting the packet and a timing for receiving a slot to wait for the receipt of a talking request from the cordless telephone remote unit 3b is constant.

Next, description will be given to an operation of the cordless telephone base unit 3a. As shown in FIG. 3, when a power supply is turned on, the control portion 311 determines the timing of a frame/slot of the time division multiple access in a self-timing and selects a synchronization slot from an optional one of the transmission slots on the master station side which are predetermined in the wireless communication apparatus, thereby starting the transmission of the control data. The control portion 311 outputs a transmission slot number and an ID of the self-apparatus which is registered in the telephone base unit ID storage portion 305 to the framing block 306 in a transmission timing of the control data. The framing block 306 adds a synchronizing signal to the transmission slot number and the ID and outputs them to the wireless portion 307 so that the control data are transmitted through the antenna 308.

The control portion 311 carries out a control for a transition to the idle state for waiting for the receipt of a talking request from the cordless telephone remote unit 3b in slots excluding slots corresponding to the synchronization slot in the transmission slots on the slave station (cordless telephone remote unit 3b) side predetermined in the wireless communication apparatus.

Finally, description will be given to an operation of the cordless telephone remote unit 3b. As shown in FIG. 4, first of all, the control portion 410 searches for the control data of the cordless telephone base unit 3a which are stored in the telephone base unit ID storage portion 412 in a continuous receipt, receives the control data to give a notice of a transmission slot of a control slot transmitted by the cordless telephone base unit 3 which are stored in the telephone base unit ID storage portion 412, and establishes the synchronization of the cordless telephone base unit 3a with the frame/slot in the time division multiple access in the same manner as in the indoor apparatus 2b. After the synchronization with the cordless telephone base unit 3a is established, the control data of the indoor apparatus 2b are received in receipt slots other than the slot for receiving the control data of the cordless telephone base unit 3a (the transmission slot on the cordless telephone base unit 3a side), that is, slots other than the slot for transmitting the control data by the cordless telephone base unit 3a in the transmission slots on the master station side predetermined in the wireless communication apparatus. Upon receipt of the control data of the indoor apparatus 2b which are coincident with the ID stored in the intercom ID storage portion 413, the control portion 410 stops the receipt of the slots other than the synchronization slot for receiving the control data of the cordless telephone base unit 3a and the broadcast slot for receiving the control data of the indoor apparatus 2b, thereby carrying out a transition to a waiting state.

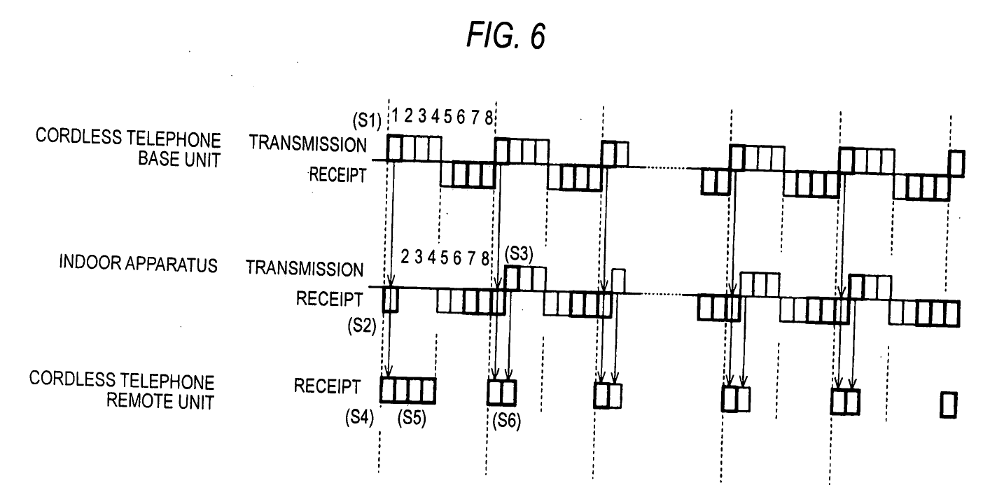

With reference to FIGS. 6 to 8, next, description will be given to the states of the transmission slot and the receipt slot which are brought when the indoor apparatus 2b, the cordless telephone base unit 3a and the cordless telephone remote unit 3b carry out a communication. FIGS. 6 to 8 are diagrams for explaining the states of the transmission slot and the receipt slot which are brought when the communication is carried out in the wireless communication apparatus 1 according to the first embodiment of the invention.

As shown in FIG. 6, in the example, there is described a slot arrangement having a time division multiplex in which one frame is constituted by transmission slots on the master station side predetermined in the wireless communication apparatus, that is, slots 1 to 4, and is similarly constituted by transmission slots on the slave station side, that is, slots 5 to 8. Referring to the time slot of the wireless communication apparatus 1, the transmission slots are constituted by four slots and the receipt slots corresponding to the transmission slots are constituted by four slots.

First of all, when the power supply is turned on, the cordless telephone base unit 3a determines the timing of a frame/slot of the time division multiple access in a self-timing and selects an optional one of the transmission slots on the master station side which are predetermined in the wireless communication apparatus, thereby starting the transmission of the control data (S1). FIG. 6 shows an example in which the cordless telephone base unit 3a selects the slot 1 to start the transmission of the control data, and the slot for transmitting the control data is set to be the slot 1 of the transmission slot which becomes the synchronization slot.

Based on the control data transmitted in the synchronization slot, the synchronization of the indoor apparatus 2b is established (S2). The indoor apparatus 2b selects the transmission slots other than the synchronization slot in the transmission slots on the master station side predetermined in the wireless communication apparatus and transmits the control data as the broadcast slot. In the embodiment, the control data are transmitted by setting, as the broadcast slot, the slot 2 to be a next slot to the synchronization slot (S3).

Based on the control data transmitted in the synchronization slot, similarly, the synchronization of the cordless telephone remote unit 3b is established (S4). The cordless telephone remote unit 3b waits for the control data transferred from the indoor apparatus 2b in a time width decided based on a time position of the synchronization slot when the synchronization is established in the synchronization slot (S5). In other words, the cordless telephone remote unit 3b waits for the control data transferred from the indoor apparatus 2b in the slots 2 to 4. Upon receipt of the control data from the indoor apparatus 2b, then, the cordless telephone remote unit 3b stops the receipt of the slots other than the slot (the synchronization slot) for receiving the control data from the cordless telephone remote unit 3b and the slot (the broadcast slot) receiving the control data from the indoor apparatus 2b (S6). In FIG. 6, the slot 2 to be a next slot to the synchronization slot is the broadcast slot. Therefore, the control data transferred from the indoor apparatus 2b are waited in the slot 2.

The transmission of the control data is carried out by the cordless telephone base unit 3a in the synchronization slot every slot 1 in each frame because of the slot for establishing the synchronization with the indoor apparatus 2b and the cordless telephone remote unit 3b. However, the control data are transmitted by the indoor apparatus 2b in the broadcast slot only when some control data are to be transmitted except that the transmission is carried out in the slot 2 of the first frame. The reason is as follows. Since the cordless telephone remote unit 3b and the indoor apparatus 2b establish the synchronization with the cordless telephone base unit 3a in the synchronization slot respectively, both the cordless telephone remote unit 3b and the indoor apparatus 2b are synchronized with each other. After transmitting the control data by setting the slot 2 in the first frame to be the broadcast slot, accordingly, the indoor apparatus 2b carries out the transmission when a visitor arrives and the call detecting portion 103 detects a call and transmits a call request, for example.

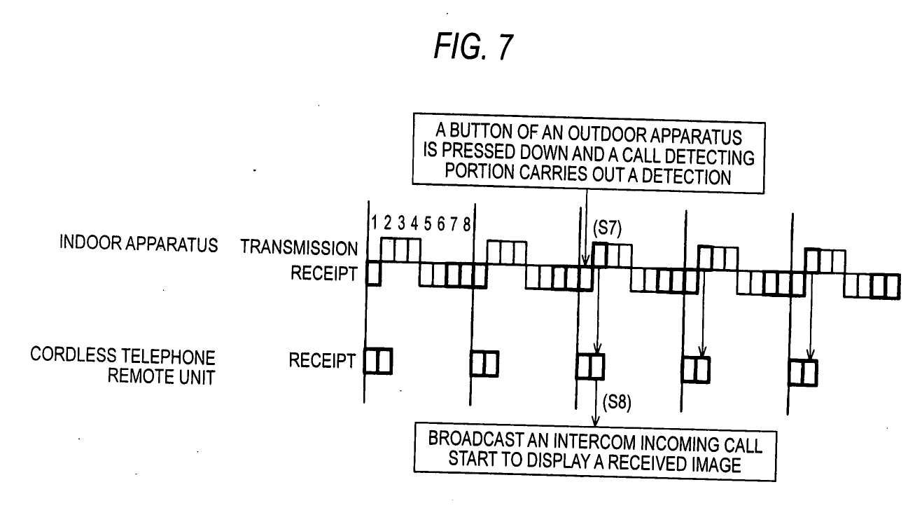

With reference to FIG. 7, description will be given to a state of a communication of the indoor apparatus 2b and the cordless telephone remote unit 3b which is brought when the call detecting portion 103 of the outdoor apparatus 2a detects a call of a visitor.

As shown in FIG. 7, the indoor apparatus 2b starts to transmit an intercom call request as control data together with image data to the cordless telephone remote unit 3b in the broadcast slot of the slot 2 when the call detecting portion 103 of the outdoor apparatus 2a detects the call in a state in which nothing is transmitted in the slot 2 to be the broadcast slot (S7).

The cordless telephone remote unit 3b displays the image data on the monitor 414, and at the same time, the broadcasting portion 401 gives information to a user (S8). At this time, the cordless telephone remote unit 3b continuously receives the control data given in the synchronization slot from the cordless telephone base unit 3a while carrying out an incoming call from the indoor apparatus 2b. For this reason, also in the case in which the incoming call is received from the telephone line 4, it is possible to detect and broadcast the incoming call.

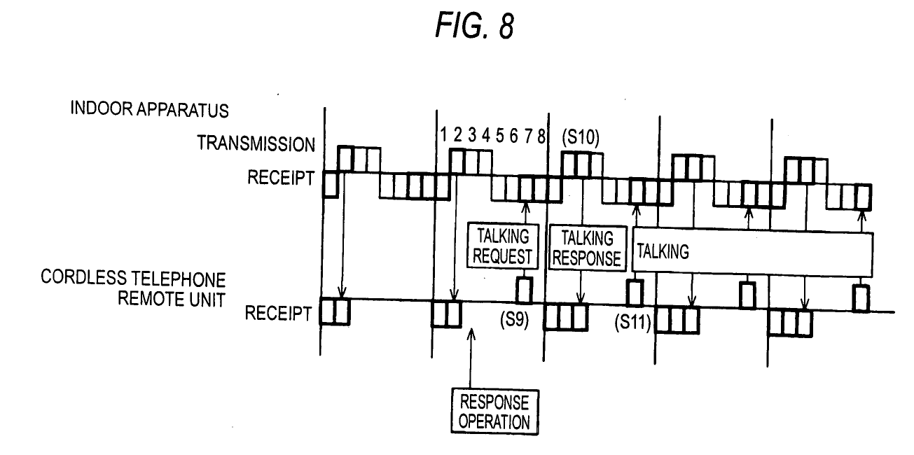

With reference to FIG. 8, next, description will be given to the state of the communication which is carried out when the cordless telephone remote unit 3b responds to an intercom incoming call notice received from the indoor apparatus 2b.

As shown in FIG. 8, when the call request is received from the indoor apparatus 2b to the cordless telephone remote unit 3b so that the user causes the cordless telephone remote unit 3b to carry out a response operation, a talking request is transmitted to the indoor apparatus 2b and a receipt slot corresponding to the slot transmitting the talking request is started to be received. At this time, transmission slots excluding the slots (slots 5 and 6) corresponding to the synchronization slot and the broadcast slot from the transmission slots (slots 5 to 8) on the predetermined slave station side are selected as the slots for transmitting the talking request. In the embodiment, there is shown an example in which the cordless telephone remote unit 3b transmits the talking request in the slot 7 and receives a response to the talking from the indoor apparatus 2b in the slot 3 (S9).

Upon receipt of the talking request, the indoor apparatus 2b transmits the talking response by using the transmission slot corresponding to the slot receiving the talking request, that is, the slot 3 (S10).

Upon receipt of the talking response, then, the cordless telephone remote unit 3b starts talking from the next slot 7 (S11). Subsequently, voice data are transmitted/received through the indoor apparatus 2b and the cordless telephone remote unit 3b in the slots 3 and 7, and voices of the outdoor apparatus 2a and the cordless telephone remote unit 3b are linked so that the user can carry out a transition to a talking state to a visitor. At this time, the cordless telephone remote unit 3b receives image data transmitted in the broadcast slot from the indoor apparatus 2b and continuously displays the image data on the monitor 414 even if the talking to the indoor apparatus 2b is started.

Moreover, the cordless telephone remote unit 3b continuously receives the control data received in the synchronization slot from the cordless telephone base unit 3a even if the talking to the indoor apparatus 2b is started. Also in the case in which the incoming call is received from the telephone line 4 when the cordless telephone remote unit 3b and the indoor apparatus 2b carry out the talking, therefore, the incoming call can be detected and broadcast.

Also in case of an incoming call received from the telephone line 4, as described above, the cordless telephone base unit 3a broadcasts the incoming call in the synchronization slot and the cordless telephone remote unit 3b receiving the incoming call displays, on the monitor 414, a telephone number of a partner which is received from the cordless telephone base unit 3a, thereby carrying out a transition to a calling state. At this time, the cordless telephone remote unit 3b continuously carries out the receipt in the broadcast slot. Also in the case in which a call of a visitor at an entrance is received from the indoor apparatus 2b, therefore, it is possible to detect and broadcast the call.

When the user performs a responding operation during calling, the transmission slots other than the transmission slots corresponding to the synchronization slot and the broadcast slot are selected to give a talking request to the cordless telephone base unit 3a, thereby carrying out a transition to a telephone talking state. At this time, the cordless telephone remote unit 3b continuously performs the receipt in the broadcast slot also during the telephone talking. Also in the case in which the call of the visitor at the entrance is received from the indoor apparatus 2b, therefore, it is possible to detect and broadcast the call.

### Second Embodiment

A wireless communication apparatus according to a second embodiment of the invention will be described below with reference to the drawings.

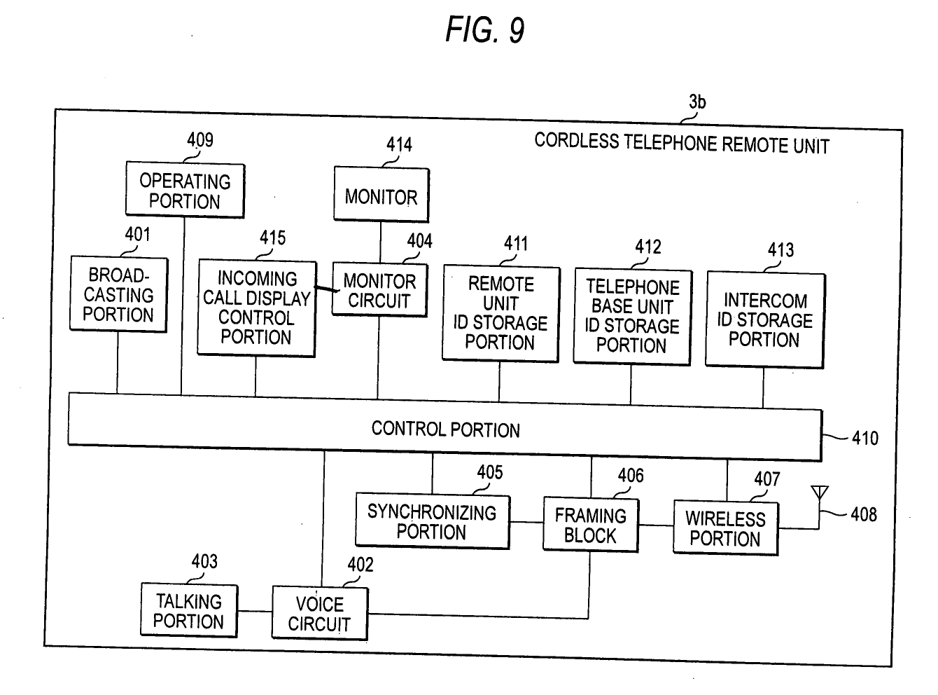

FIG. 9 is a diagram for explaining a structure of a cordless telephone remote unit of a cordless telephone according to the second embodiment of the invention.

In the embodiment, the same portions as those in the first embodiment have the same reference numerals and detailed description thereof will be omitted.

The second embodiment is different from the first embodiment in that an incoming call display control portion 415 is newly provided in the structure of the cordless telephone remote unit in the cordless telephone. Others are the same as in the first embodiment and detailed description thereof will be omitted.

The incoming call display control portion 415 is connected to a control portion 410 and a monitor circuit 404, and receives, together with an incoming call notice from the control portion 410, a telephone number sent from a cordless telephone base unit 3a in an outside line incoming call received from a telephone line 4 and an image of a visitor which is sent from an indoor apparatus 2b in an entrance incoming call received from an outdoor apparatus 2a, and gives an instruction for a display to the monitor circuit 404 in order to broadcast the incoming call to a user through a screen display on a monitor 414. Furthermore, there is carried out a screen display control for an incoming call broadcast in the case in which an entrance incoming call from the outdoor apparatus 2a and an outside line incoming call from the telephone line 4 are generated at a time, an incoming call broadcast in the case in which an incoming call is generated from the outdoor apparatus 2a during outside line talking to the telephone line 4, and an incoming call broadcast in the case in which an incoming call is generated from the telephone line 4 during entrance talking to the outdoor apparatus 2a, and an instruction for a display is thus given to the monitor circuit 404.

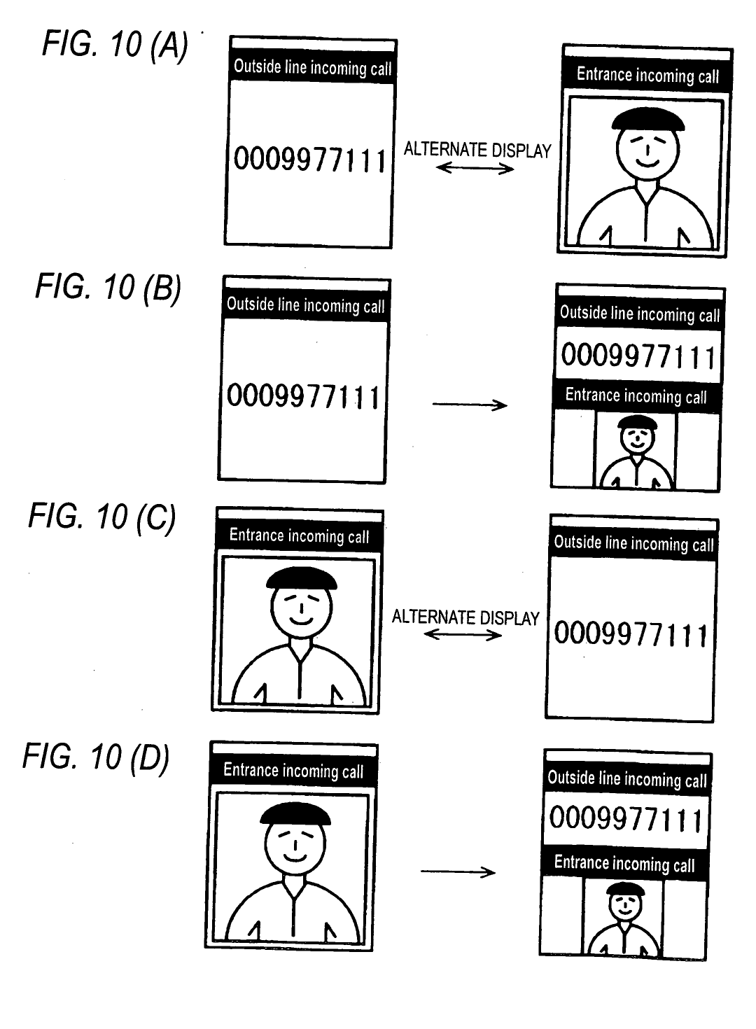

An incoming call display to be controlled by the incoming call display control portion 415 will be described below with reference to FIGS. 10 to 13.

FIG. 10 is a view showing an example of a screen display in the case in which two incoming calls are generated at a time in a wireless communication apparatus according to the second embodiment of the invention.

Referring to FIG. 10(A), in the case in which an entrance incoming call is generated from the outdoor apparatus 2a during an outside line incoming call received from the telephone line 4, an outside line incoming call display and an entrance incoming call display are carried out alternately at a certain interval in order to broadcast both of the incoming calls.

Referring to FIG. 10(B), in the case in which an entrance incoming call is generated from the outdoor apparatus 2a during an outside line incoming call received from the telephone line 4, an outside line incoming call display and an entrance incoming call display are carried out over a screen at a time in order to broadcast both of the incoming calls.

Referring to FIG. 10(C), in the case in which an outside line incoming call is generated from the telephone line 4 during the entrance incoming call received from the outdoor apparatus 2a, the entrance incoming call display and the outside line incoming call display are carried out alternately at a certain interval in order to broadcast both of the incoming calls.

Referring to FIG. 10(D), in the case in which an outside line incoming call is generated from the telephone line 4 during the entrance incoming call received from the outdoor apparatus 2a, the entrance incoming call display and the outside line incoming call display are carried out over a screen at a time in order to broadcast both of the incoming calls.

By carrying out such a display control, it is possible to broadcast the two incoming calls to the user simply.

In the case in which the display is alternately carried out, the display interval may be fixed or changeable.

Referring to a display position in the case in which the two incoming calls are displayed on a screen at a time, moreover, the outside line incoming call screen and the entrance incoming call screen may be always set into upper and lower parts respectively, the entrance incoming call screen and the outside line incoming call screen may be always set into the upper and lower parts respectively, either of the incoming calls which is generated earlier may be always displayed in the upper part, or either of the incoming calls which is generated later may be always displayed in the upper part as in the example of the display.

If an alternate display is stopped when an operation for responding to either of the incoming calls is carried out by a button operation of an operating portion 409 by a user during an alternate display, a transition to a talking state is carried out when the same operation is performed again, and an incoming call alternate display state is returned again and an incoming call response destination can be selected again when another button operation is carried out, a convenience can be enhanced still more, which is not shown.

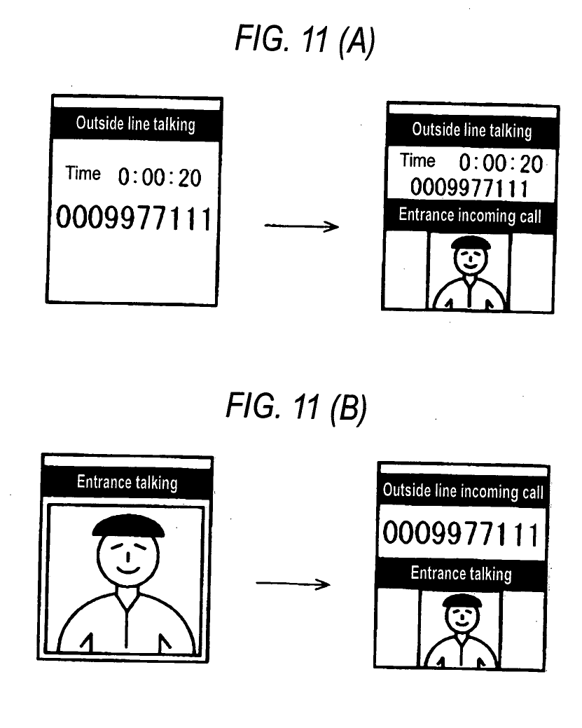

FIG. 11 is a view showing an example of a screen display in the case in which another incoming call is generated during talking in the wireless communication apparatus according to the second embodiment of the invention.

Referring to FIG. 11(A), in the case in which an entrance incoming call is generated from the outdoor apparatus 2a during outside line talking to the telephone line 4, a display obtained during the outside line talking and a display for the entrance incoming call are carried out over a screen at a time in order to broadcast the entrance incoming call.

Referring to FIG. 11(B), in the case in which an outside line incoming call is generated from the telephone line 4 during entrance talking to the outdoor apparatus 2a, a display obtained during the entrance talking and a display for the outside line incoming call are carried out over a screen at a time in order to broadcast the outside line incoming call.

By carrying out such a display control, it is possible to simply broadcast, to the user, another incoming call generated during the talking.

Referring to a display position, an outside line incoming call screen or an outside line talking screen and an entrance incoming call screen or an entrance talking screen may be always set into upper and lower parts respectively, the entrance incoming call screen or the entrance talking screen and the outside line incoming call screen or the outside line talking screen may be always set into the upper and lower parts respectively, the talking screen may be always displayed in the upper part or the incoming call screen may be always displayed in the upper part as in the example of the display.

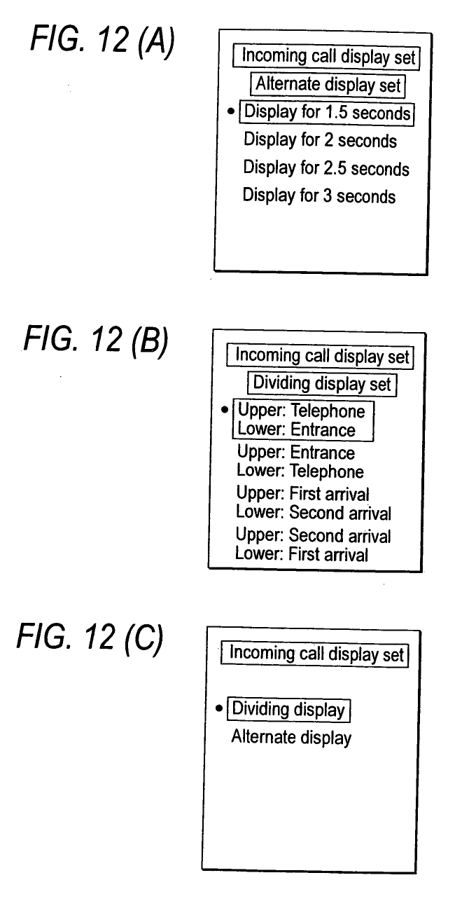

FIGS. 12A to 12C are view showing an example of a display method selecting and setting screen in the case in which two incoming calls are generated at a time in the wireless communication apparatus according to the second embodiment of the invention.

FIG. 12(A) shows a setting screen for causing the user to specify a display interval in the case in which the respective incoming call notice screens are alternately displayed when the outside line incoming call and the entrance incoming call are generated at a time.

FIG. 12(B) shows a setting screen for causing the user to specify a display method in the case in which the respective screens are displayed on a screen when the outside line incoming call and the entrance incoming call are generated at a time.

FIG. 12(C) shows a setting screen for causing the user to specify a screen display method in the case in which the outside line incoming call and the entrance incoming call are generated at a time.

Thus, the user can be caused to specify a screen displaying way in the case in which the outside line incoming call and the entrance incoming call are generated at a time. Consequently, the convenience can be enhanced still more.

By the method specified in FIG. 12(B), moreover, it is also possible to carry out a screen display in the case in which another incoming call is generated during talking or to specify a displaying way by another setting screen.

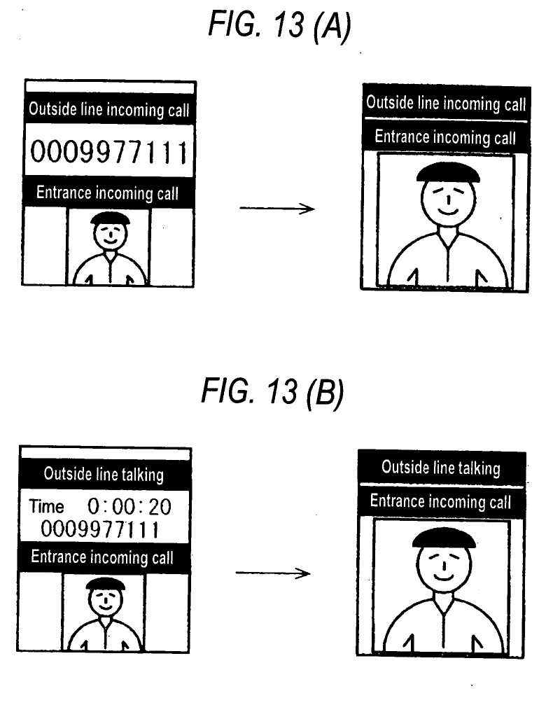

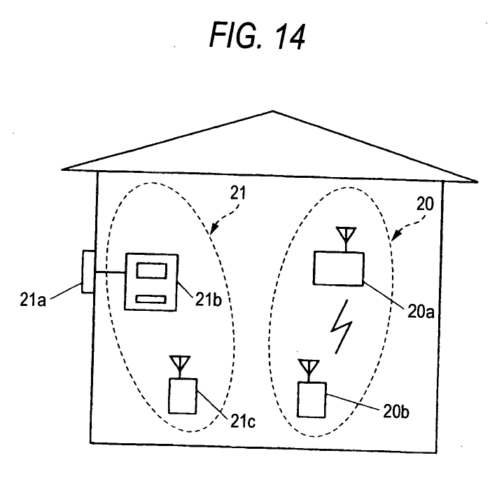

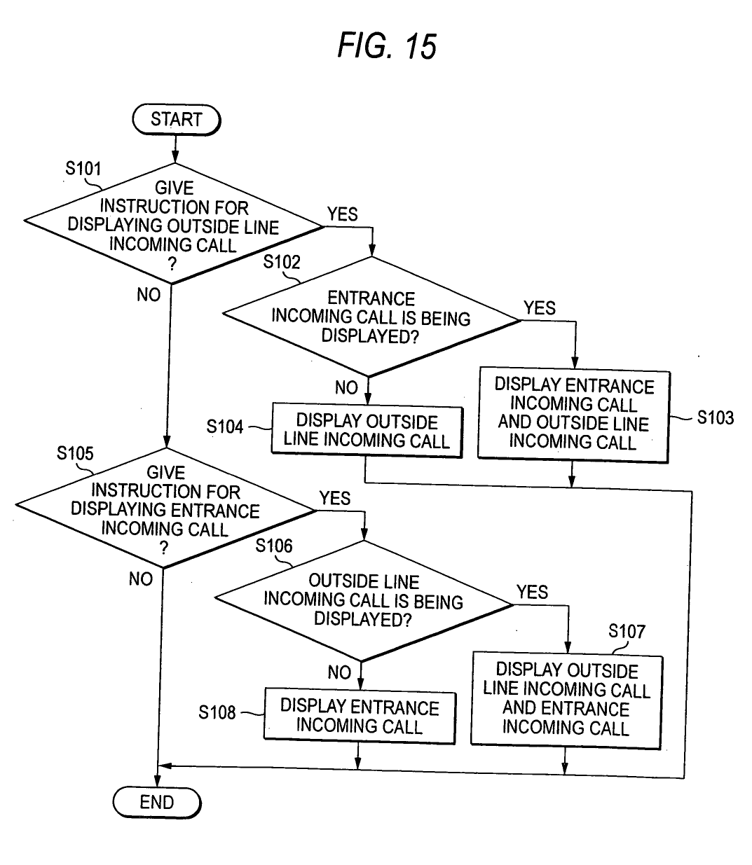

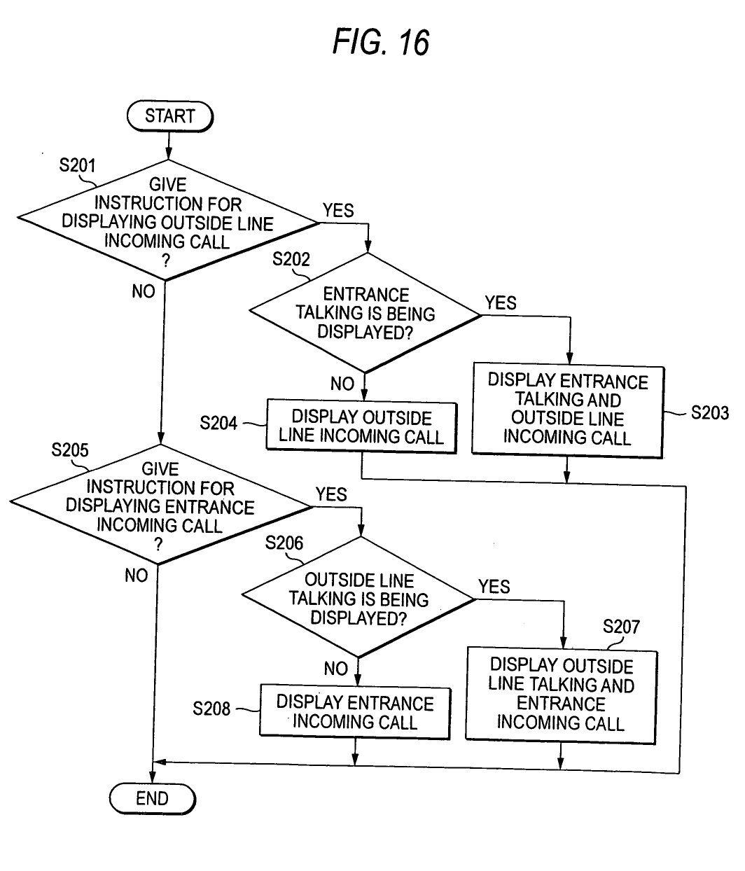

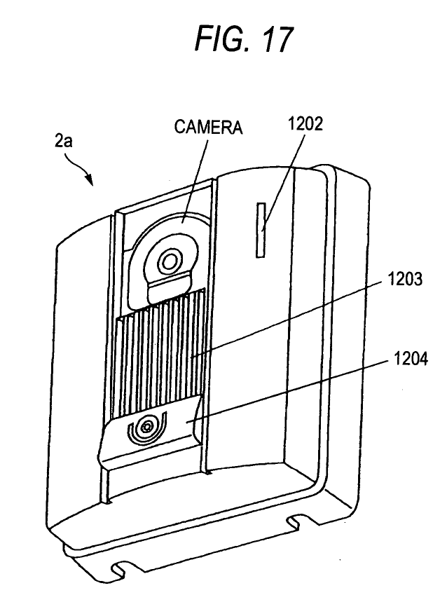

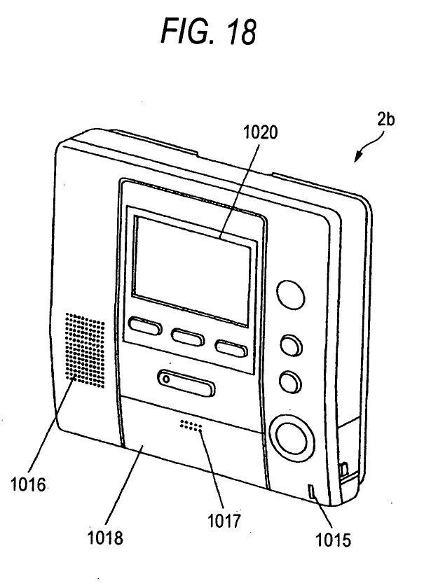

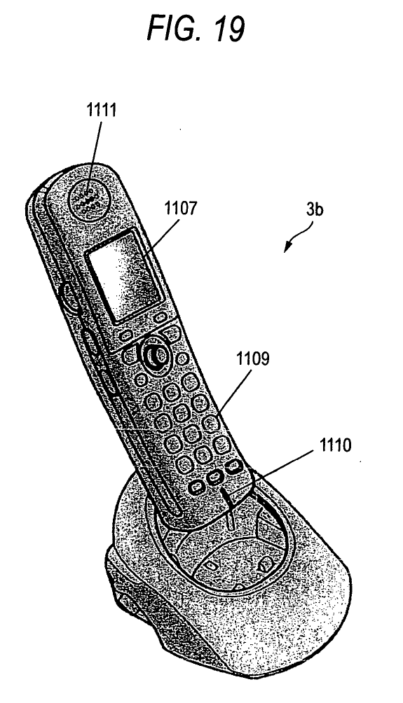

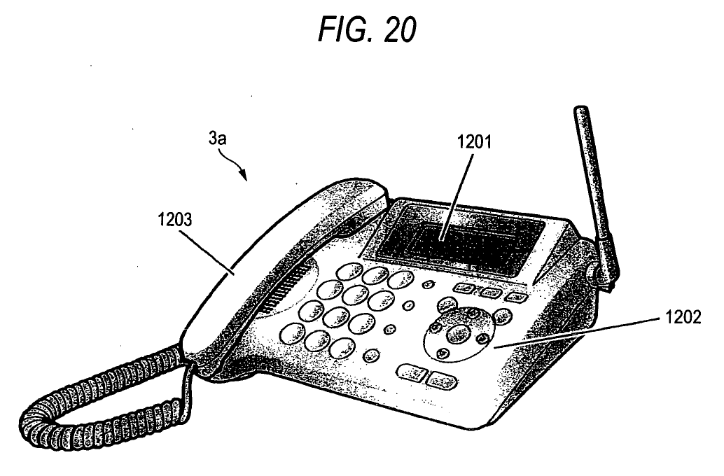

FIG. 13 is a view showing an example of a display in the case in which a size of a visitor image display during an entrance incoming call is changed in the wireless communication apparatus according to the second embodiment of the invention.

FIG. 13(A) shows an example of a display in the case in which the size of the visitor image display during the entrance incoming call is changed by the button operation of the operating portion 409 which is carried out by the user when the outside line incoming call display and the entrance incoming call display are performed over a screen at a time.

FIG. 13(B) shows an example of a display in the case in which the size of the visitor image display during the entrance incoming call is changed by the button operation of the operating portion 409 which is carried out by the user when the outside line talking display and the entrance incoming call display are performed over a screen at a time.

By changing the size of the display of the visitor image, thus, it is possible to confirm the visitor more easily, thereby enhancing the convenience still more.

A procedure for controlling an incoming call display which is carried out in the incoming call display control portion 415 will be described below with reference to FIGS. 15 and 16.

FIG. 15 is a flowchart showing a control in the case in which two incoming calls are generated at a time in the wireless communication apparatus according to the second embodiment of the invention. Moreover, FIG. 16 is a flowchart showing a control in the case in which one of incoming calls is generated during the other's talking in the wireless communication apparatus according to the second embodiment of the invention.

First of all, the control in the case in which two incoming calls are generated at a time will be described with reference to the flowchart of FIG. 15.

The incoming call display control portion 415 first decides whether an instruction for an outside line incoming call display is received from the telephone line 4 or not upon receipt of an instruction for an incoming call display from the control portion 410 (Step S101), and further decides whether an entrance incoming call received from the outdoor apparatus 2a is being displayed or not if the instruction for the outside line incoming call display is received (Step S102). If the entrance incoming call is being displayed, the display control shown in FIG. 10(C) or (D) is carried out in order to give a notice of both of the entrance incoming call and the outside line incoming call (Step S103). If the entrance incoming call is not being displayed, a display control for giving a notice of only the outside line incoming call is carried out (Step 104).

If the instruction for the incoming call display which is received from the control portion 410 is not the instruction for the outside line incoming call display but the instruction for the entrance incoming call display (Step S105), it is decided whether the outside line incoming call received from the telephone line 4 is being displayed or not (Step 106). If the outside line incoming call is being displayed, the display control shown in FIG. 10(A) or (B) is carried out in order to give a notice of both of the outside line incoming call and the entrance incoming call (Step S107). If the outside line incoming call is not being displayed, a display control for giving a notice of only the entrance incoming call is carried out (Step S108).

With reference to the flowchart of FIG. 16, next, description will be given to the control in the case in which one of incoming calls is generated during the other's talking.

The incoming call display control portion 415 first decides whether an instruction for an outside line incoming call display is received or not upon receipt of an instruction for an incoming call display from the control portion 410 (Step S201), and further decides whether entrance talking to the outdoor apparatus 2a is being displayed or not if the instruction for the outside line incoming call display is received (Step S202). If the entrance talking is being displayed at this time, the display control shown in FIG. 11(B) is carried out in order to give a notice of the outside line incoming call (Step S203). If the entrance incoming call talking is not being displayed, a display control for giving a notice of only the outside line incoming call is carried out (Step 204).

If the instruction for the incoming call display which is received from the control portion 410 is not the instruction for the outside line incoming call display but the instruction for the entrance incoming call display (Step S205), it is decided whether the outside line talking to the telephone line 4 is being displayed (Step 206). If the outside line talking is being displayed, the display control shown in FIG. 11(A) is carried out in order to give a notice of the entrance incoming call (Step S207). If the outside line incoming call is not being displayed, a display control for giving a notice of only the entrance incoming call is carried out (Step S208).

FIG. 17 is a view showing an appearance of the outdoor apparatus 2a.

A camera 1201 for setting a visitor to be an image signal, a microphone 1202 and a speaker 1203 which serve to carry out talking to the visitor, and a call button 1204 for transmitting the arrival of the visitor to the indoor apparatus 2b and the cordless telephone remote unit 3b are provided on the front surface of the outdoor apparatus 2a.

FIG. 18 is a view showing an appearance of the indoor apparatus 2b.

An LCD panel 1020 for projecting an image of the visitor in the outdoor apparatus 2a, a key matrix switch 1018, and an LED 1017 for displaying the arrival through a light are provided on the front surface of the indoor apparatus 2b. Moreover, there are provided a microphone 1015 and a speaker 1016 for carrying out talking to the visitor in the outdoor apparatus 2a.

FIG. 19 is a view showing an appearance of a cordless telephone remote unit 3b.

The cordless telephone remote unit 3b is portable. An LCD panel 1107 for projecting the image of the visitor in the outdoor apparatus 2a, a key matrix switch 1109 and an LED 1108 for displaying the arrival through a light are provided on the front surface of the cordless telephone remote unit 3b. Moreover, there are provided a microphone 1110 and a speaker 1111 for carrying out talking to the visitor in the outdoor apparatus 2a.

In the cordless telephone remote unit of FIG. 19, it is possible to receive a call, to input a telephone number by using the key matrix switch 1109 and to make a call.

FIG. 20 is a view showing an appearance of the cordless telephone base unit 3a. An operation for carrying out making a call and responding to an incoming call is performed by using an operation panel 1202 and a state corresponding to the operation is displayed on an LCD panel 1201. Moreover, it is possible to carry out talking by using a handset 1203.

By this structure, the visitor can have a conversation with an indoor user by utilizing the outdoor apparatus 2a. The image of the outdoor apparatus 2a can be output to the indoor user through the cordless telephone remote unit 3b which is also connected to the cordless telephone base unit 3a via the indoor apparatus 2b. Moreover, it is possible to have a conversation by the outdoor apparatus 2a and the cordless telephone remote unit 3b. Therefore, it is possible to produce an advantage that the indoor user can use the cordless telephone remote unit 3b while holding the cordless telephone remote unit 3b and moving or putting the cordless telephone remote unit 3b in a convenient place during waiting.

While the main master station is set to be the cordless telephone base unit and the sub master station is set to be the indoor apparatus in the embodiment described above, the main master station may be set to be the indoor apparatus and the sub master station may be set to be the cordless telephone base unit.

Moreover, a wireless monitoring camera device may be provided in place of an intercom.

This application is based upon and claims the benefit of priority of Japanese Patent Application No. 2005-191428 filed on Jun. 30, 2005, the contents of which are incorporated herein by reference in its entirety.

Since the wireless communication apparatus according to the invention can detect and broadcast incoming calls generated from a plurality of master stations at a time in synchronization with the master stations without requiring a plurality of wireless transmitting/receiving apparatuses, it can be used for a wireless communication apparatus in which a plurality of master stations and a slave station carry out a communication in a time division multiplex.

What is claimed is:

1. A wireless communication apparatus comprising:
a wireless communicator configured to wireless communicating with a calling telephone apparatus via a telephone base unit connected to a communication line and to wireless communicating with an indoor apparatus connected to an outdoor apparatus, the outdoor apparatus having a camera for capturing an image of a visitor in front of the outdoor apparatus;
a display configured to display data; and
a controller configured to receive a call from the calling telephone apparatus via the telephone base unit, to obtain the image of the visitor captured by the camera of the outdoor apparatus through the indoor apparatus, and to display, on the display, predetermined information indicating that the call is received at the wireless communication apparatus and the image of the visitor.

2. The wireless communication apparatus according to claim 1, wherein the communicator carries out a communication by using a communication frame including a plurality of descending slots, receives information about the call received from the communication line through a first descending slot, and receives the image data captured by the camera of the outdoor apparatus through a second descending slot.

3. The wireless communication apparatus according to claim 1, wherein the controller causes the display portion to alternately display the information about a call received from the communication line through the telephone base unit and the image data captured by the camera of the outdoor apparatus.

4. The wireless communication apparatus according to claim 3, further comprising a panel, and
wherein the control portion inputs, from the panel, an interval of an alternate display in a display of the call received from the communication line through the telephone base unit and a display of the image data captured by the camera and causes the display to carry out a display based on the interval of the alternate display.

5. The wireless communication apparatus according to claim 1, wherein the display divides a display range into a plurality of predetermined ranges and displays them, and
the controller causes the display to display the call received from the communication line through the telephone base unit and the image data captured by the camera in a division into a plurality of ranges.

6. The wireless communication apparatus according to claim 5, further comprising a panel, and
wherein the control portion inputs, from the panel, a position of a display of the call received from the communication line and a position of a display of the image data captured by the camera in the case in which the information about the call received from the communication line through the telephone base unit and the image data captured by the camera are displayed on the display portion at the same time in a division, and causes the display to carry out the display based on the positions of the display.

7. The wireless communication apparatus according to claim 3, further comprising a panel, and
wherein the control portion inputs, from the panel, a first display procedure for causing the display portion to display the information about the call received from the communication line through the telephone base unit and the image data captured by the camera at the same time in a division or a second display procedure for causing the display portion to alternately display the information about the call received from the communication line through the telephone base unit and the image data captured by the camera of the outdoor apparatus, and causes the display portion to carry out the display based on the display procedure which is input.

8. The wireless communication apparatus according to claim 1, wherein the wireless communicator receives a signal indicative of a call of the outdoor apparatus which is received from the indoor apparatus through a wireless communication, and
the controller carries out a control for displaying information about the call of the outdoor apparatus in addition to information about a call received from the communication line when receiving a signal indicative of the call of the outdoor apparatus via the indoor apparatus during a control of the data for displaying, on the display, the information about the call received from the communication line.

9. The wireless communication apparatus according to claim 1, wherein the controller displays the information about the call received from the communication line in addition to the image data when the wireless communicator receives, from the telephone base unit, a signal indicative of the call received from the communication line during a control of the data for causing the display to display the image data captured by the camera of the outdoor apparatus through the indoor apparatus.

10. A wireless communication apparatus comprising:
wireless communicator for wireless communicating with a telephone base unit connected to a communication line and an indoor apparatus connected to an outdoor apparatus having a camera for capturing an image of a visitor;
display for displaying data; and
control for causing the display to display an effect of talking to the communication line through the telephone base unit and image data captured by the camera upon receipt of the image data captured by the camera through the indoor apparatus during the display of the effect of the talking to the communication line.

11. The wireless communication apparatus according to claim 10, wherein a communication for the talking to the communication line is transmitted in a first descending slot and the image data captured by the camera of the outdoor apparatus are received in a second descending slot.

12. The wireless communication apparatus according to claim 10, wherein the controller causes the display to display the image data captured by the camera in a division at the same time during the display of the effect of the talking to the communication line through the indoor apparatus.

13. The wireless communication apparatus according to claim 10, wherein the wireless communicator receives a signal indicative of a call of the outdoor apparatus which is received from the indoor apparatus through a wireless communication, and
the controller displays information about the call of the outdoor apparatus in addition to information about the talking to the communication line when receiving a signal indicative of the call of the outdoor apparatus via the indoor apparatus during a control of the data for displaying, on the display, the information about the talking to the communication line.

14. A wireless communication apparatus comprising:
wireless communicator for wireless communicating with a telephone base unit connected to a communication line and an indoor apparatus connected to an outdoor apparatus having a camera for capturing an image of a visitor;
display for displaying data; and
controller for causing the display to display image data captured by the camera during talking to the outdoor apparatus through the telephone base unit and an effect of a call received from the communication line when receiving information about the call received from the communication line through the indoor apparatus during the display of the image information captured by the camera in the talking to the outdoor apparatus.

15. The wireless communication apparatus according to claim 14, wherein the information about the call received from the communication line through the telephone base unit is received in a first descending slot and the image data captured by the camera of the outdoor apparatus are received in a second descending slot.

16. The wireless communication apparatus according to claim 14, wherein the controller causes the display portion to display the information about the call received from the communication line through the telephone base unit at the same time in a division during the display of the image data captured by the camera.

17. The wireless communication apparatus according to claim 14, wherein the controller carries out a control for displaying information about the call received from the communication line in addition to the display of the image data when the wireless communicator receives, from the telephone base unit, a signal indicative of the call received from the communication line during a control of the data for causing the display to display the image data captured by the camera during talking to the outdoor apparatus through the indoor apparatus.

18. A method for controlling a wireless communication apparatus, the wireless communication apparatus wireless communicating with a calling telephone apparatus via a telephone base unit connected to a communication line, the wireless communication apparatus wireless communicating with an indoor apparatus connected to an outdoor apparatus, the outdoor apparatus having a camera for capturing an image of a visitor, the wireless communication apparatus having a display, the method comprising:
receiving a call from the calling telephone apparatus via the telephone base unit;
obtaining the image of the visitor captured by the camera of the outdoor apparatus through the indoor apparatus; and
displaying predetermined information indicating that the call is received at the wireless communication apparatus and the image of the visitor on the display.

19. A wireless communication apparatus comprising:
a wireless communicator configured to wireless communicating with a communicating line and to wireless communicating with a camera unit having a camera for capturing an image of a visitor;
a display configured to display data; and
a controller configured to display, on the display, predetermined information indicating that the call is received at the wireless communication apparatus and an image information captured by the camera, which is received from the camera unit.

20. The wireless communication apparatus according to claim 19, wherein said camera unit includes an outdoor apparatus having the camera for capturing the image of the visitor, and an indoor apparatus connected to the outdoor apparatus, and
said wireless communicator wireless communicates with the indoor apparatus.

21. A communication apparatus comprising:
a communicator configured to communicating with a communicating line and to communicating with a camera unit having a camera for capturing an image of a visitor;
a display configured to display data; and
a controller configured to display, on the display, predetermined information indicating that the call is received at the communication apparatus and an image information captured by the camera, which is received from the camera unit.

22. The communication apparatus according to claim 21, wherein said camera unit includes an outdoor apparatus having the camera for capturing the image of the visitor, and an indoor apparatus connected to the outdoor apparatus, and
said communicator communicates with the indoor apparatus.
